(19) United States
(12) Patent Application Publication
(10) Pub. No.: US 2004/0102559 A1
(43) Pub. Date: May 27, 2004

(54) Polyamide resin composition

(76) Inventors: Hiroshi Oyamada, Chiba (JP); Shigeo Mori, Chiba (JP)

Correspondence Address: BIRCH STEWART KOLASCH & BIRCH, PO BOX 747, FALLS CHURCH, VA, 22040-0747, US

(21) Appl. No.: 10/702,595

(22) Filed: Nov. 7, 2003

(30) Foreign Application Priority Data
Nov. 7, 2002 (JP) 2002-323607

(51) Int. Cl. C08K 3/34; C08K 3/40; C08K 3/04

(52) U.S. Cl. 524/445; 524/449; 524/451; 524/494; 524/495

(57) ABSTRACT

The present invention provides a polyamide resin composition which contains: (A) 30 to 70 parts by weight of a polyamide resin; (B) 70 to 30 parts by weight of an inorganic filler; and (C) carbon black in an amount of 0.05 to 10 parts by weight per 100 parts by weight of the sum of components (A) and (B), wherein the inorganic filler (B) contains (b1) glass fiber, and (b2) at least one species selected from the group consisting of wollastonite, talc, kaolin and mica; the carbon black (C) has an average primary particle size of 20 nm or less and an average aggregate size of 50 to 120 nm. Also disclosed is a molded article obtained from the polyamide resin composition.

### FIELD OF THE INVENTION

The present invention relates to a polyamide resin composition excellent in weather resistance. More particularly, it relates to a polyamide resin composition capable of providing a molded article having excellent appearance (in gloss and jet-black chromaticity) and being hardly discolored in black and free from standing out glass fiber under an outdoor condition, particularly under a condition where it is exposed to a rainfall.

### BACKGROUND OF THE INVENTION

Polyamide resin has widely been utilized as the parts of automobiles and electric/electronic goods since it has excellent mechanical and thermal properties and excellent oil-resistant properties. Reinforced polyamide resins prepared by blending a polyamide and glass fiber have high mechanical properties and high heat- and chemical-resistant properties, and can be adapted to the parts which have so far been made of metal. Thus, investigations have actively been made from the aspect of weight saving and process rationalization in recent years. In particular, a reinforced polyamide material having high mechanical characteristics, produced in combination with glass fiber or with glass fiber and inorganic filler such as wollastonite at a high concentration thereof has been utilized.

Polyamide resin compositions combined with inorganic fillers such as glass fiber at high concentrations have been proposed in U.S. Pat. Nos. 5,371,132 and 6,191,207. These polyamide resin compositions, since they have excellent in surface appearance of molded articles obtained therefrom as well as rigidity, have been utilized in a variety of interior or exterior parts of automobiles and OA furniture.

On the other hand, when they are used outdoors as exterior parts in automobiles, they are often used as black molded articles by being blended with carbon black. Particularly, when they are used in such an outdoor condition as exposure to rainfalls, they are strongly required to have weather resistance in such conditions (no deterioration of appearance and less black discoloration in the molded articles).

JP 4-370148 A discloses a polyamide resin composition comprising polyamide, glass fiber, carbon black and nigrosine, from which a molded article having good appearance and high weather resistance can be produced. In the publication, however, there is no disclosure as to black discoloration and standing out of glass fiber, merely disclosing the retention rate of strength in regard to weather resistance. According to the follow-up research by the present inventors, a large number of glass fiber standing out on the surface of a test piece were observed after exposure in a weather resistance test, giving quite insufficient results in black discoloration and standing-out of glass fiber.

JP 6-32981 A proposes a polyamide resin composition comprising a semi-aromatic polyamide, glass fiber and/or mica, carbon black and a copper compound. The composition, however, is insufficient in the suppression of black discoloration after evaluation of weather resistance and can provide a molded article having good appearance only when molded with a high temperature mold, resulting in great limitations on its utility.

### SUMMARY OF THE INVENTION

An object of the invention is to provide a polyamide resin composition excellent in weather resistance with less discoloration, which is capable of providing a molded article having excellent gloss and jet-black chromaticity and hardly discolored in black and free from standing out glass fiber even under an outdoor condition, particularly under a condition where it is exposed to a rainfall.

Another object of the invention is to provide a molded article obtained from the polyamide resin composition.

Other objects and effects of the invention will become apparent from the following description.

The present inventors made extensive investigations to solve the above-described problems and found that the problems can be solved by providing a resin composition comprising a polyamide resin, particularly polyamide resin containing a specific amount of aromatic ring-containing polymer unit, glass fiber, a specific inorganic filler and a specific carbon black, and its molded article. Thus, the invention was completed.

That is, the above-described objects of the invention have been achieved by providing the followings:

1) A polyamide resin composition which comprises:

(A) 30 to 70 parts by weight of a polyamide resin;

(B) 70 to 30 parts by weight of inorganic filler; and

(C) carbon black in an amount of 0.05 to 10 parts by weight per 100 parts by weight of the sum of components (A) and (B), wherein

said inorganic filler (B) comprises (b1) glass fiber, and (b2) at least one species selected from the group consisting of wollastonite, talc, kaolin and mica;

said carbon black (C) has an average primary particle size of 20 nm or less and an average aggregate size of 50 to 120 nm.

2) The polyamide resin composition according to item 1) above, wherein said polyamide resin comprises a semi-aromatic polyamide and contains an aromatic-containing polymer unit in an amount of 10 to 90 mole %.

3) The polyamide resin composition according to item 1) above, wherein said polyamide resin (A) is a semi-aromatic polyamide comprising:

60 to 95% by weight of a hexamethylene adipamide unit;

0 to 10% by weight of a capramide unit; and

5 to 40% by weight of hexamethylene isophthalamide unit.

4) The polyamide resin composition according to item 1) above, wherein said inorganic filler (B) comprises glass fiber and wollastonite.

5) The polyamide resin composition according to item 1) above, wherein the weight ratio of (b2) to (b1) is from 0.2 to 3.

6) The polyamide resin composition according to item 1) above, further comprising (D) a copper compound in an amount of 5,000 ppm or less in terms of copper contained therein based on the weight of component (A).

7) The polyamide resin composition according to item 1) above, further comprising (E) an azine dye in an amount of 0.01 to 2 parts by weight per 100 parts by weight of component (A).

8) A molded article obtained by molding a polyamide resin composition according to any of items 1) to 7) above.

9) The molded article according to item 8) above, which is selected from the group consisting of outer handle, outer door handle, hubcap, roof rail, side mirror base, inside rear-view mirror arm, sunroof deflector, radiator fun, radiator grill, bearing retainer, console box, sun visor arm, spoiler, slide door rail cover, legs of desk and chair, seat support, armrest, parts of wheelchair, door knob, handrail, grip bar, window knob and window lock.

### DETAILED DESCRIPTION OF THE INVENTION

(A) Polyamide Resin

As the polyamide resin in the invention, known polyamide resin such as aliphatic polyamides and semi-aromatic polyamides can be used.

The aliphatic polyamide can include a polyamide homopolymer. For example, but not by way of limitation, the polyamide homopolymer can include polyamide 6, polyamide 66, polyamide 610, polyamide 612, polyamide 11 or polyamide 12.

Alternatively, the aliphatic polyamide can include a polyamide copolymer. For example, but not by way of limitation, the polyamide copolymer can include polyamide 66/6, polyamide 66/610 or polyamide 66/612.

Additionally, the aliphatic polyamide is not limited to being only a polyamide homopolymer or a polyamide copolymer, but can also include one or more blends thereof. Further, more than one polyamide homopolymer and/or polyamide copolymermay be used together in the blend(s). In particular, when polyamide 6, polyamide 610, polyamide 612, polyamide 12, polyamide 66/6 copolymer or their blend is used, a molded article having a better appearance can be produced even if a larger amount of glass fiber and inorganic filler are blended, thus being preferred. As the semi-aromatic polyamide, a crystalline semi-aromatic polyamide or a mixture of a crystalline semi-aromatic polyamide and amorphous semi-aromatic polyamide can be used in the invention.

The crystalline semi-aromatic polyamide includes, for example, semi-aromatic polyamide containing at least one selected from: hexamethylene terephthalamide unit (hereinafter referred to as “6T component”) prepared from terephthalic acid and hexamethylenediamine; nonamethylene terephthalamide unit prepared from terephathalic acid and nonamethylenediamine; hexamethylene isophthalamide unit (hereinafter referred to as “6I component”) prepared from isophthalic acid and hexamethylenediamine; and metaxylylene adipamide (hereinafter referred to as “MXD6 component”) prepared from adipic acid and metaxylylenediamine. In this connection, the crystalline semi-aromatic polyamide containing 6T component, 6I component and MXD6 component are respectively referred to as “polyamide 6T”, “polyamide 6I” and “polyamide MXD6”.

The amorphous semi-aromatic polyamide includes polyamide prepared from terephthalic acid and trimethylhexadiamine; polyamides prepared from bis(4-amino-methylhexyl)methane, hexamethylenediamine, terephthalic acid, isophthalic acid and caprolactam; and amorphous polyamides prepared from bis(4-amino-3-methylcyclohexyl)methane, bis(4-amino-methyl-5-ethylcyclohexyl)methane, hexamethylenediamine, terephthalic acid, isophthalic acid and caprolactam.

Particularly preferred are polyamides containing an aromatic-containing polymer unit in an amount of 10 to 90 mole %. The term “aromatic ring-containing polymer unit” means a repeated unit containing one acid amide moiety (—CONH—) and one aromatic ring, specifically including the aforementioned 6I component, 6T component and MXD6 component.

The method for measuring the content of the aromatic ring-containing polymer unit includes a method of dissolving a polyamide in a solvent such as deuterated sulfuric acid or deutrated trifluoroacetic acid and then performing an NMR measurement.

In this invention, the polyamide was dissolved in deuterated trifluoroacetic acid so as to give a concentration of 2% by weight, for which ¹H-NMR was measured using Brucker's AC-300P. For the determination of the chemical shift, tetramethylsilane was used as a standard.

Particularly preferred polyamide resin in the invention is a mixture or copolymer of an aliphatic polyamide and a semi-aromatic polyamide. Particularly preferred is a mixture or copolymer of polyamide 66 and polyamide 6I or of polyamide 66, polyamide 6 and polyamide 6I. In this case, it is preferred to use polyamide 6I in the range of 5 to 40% by weight. When the content is less than 5% by weight, it becomes sometimes difficult to obtain a good appearance and weather resistance of the molded article. On the other hand, when the content is over 40% by weight, it also becomes sometimes difficult to obtain a good appearance of the molded article or to release the molded article from the mold if a sufficient cooling time is not given to the molded article in the mold, thus resulting in decrease of the productivity.

Polyamide 6 may preferably be used in an amount of 10% by weight or less. When the content is over 10% by weight, in some cases, mechanical characteristics are greatly decreased due to absorption of water or the lowering rate of the rigidity upon heating is increased.

Further preferred polyamide resin in the invention is a semi-aromatic polyamide comprising 60 to 95% by weight of a hexamethylene adipamide unit prepared from adipic acid and hexamethylenediamine, 0 to 10% by weight of a capramide unit prepared from caprolactam and 5 to 40% by weight of hexamethylene isophthalamide unit prepared from isophthalic acid and hexamethylenediamine.

As for the molecular weight of the polyamide resin for use in the invention, the viscosity ηr in a sulfuric acid solution (a solution of 1 g of polymer dissolved in 100 ml of 95.5% sulfuric acid is measured with an Ostwald viscometer at 25° C.) is generally 1.5 to 3.5, preferably 1.8 to 3.0, and more preferably 2.0 to 2.8. When ηr is lower than 1.5, the resin composition becomes brittle, and striking drawling occurs upon molding from the leading end of a cylinder nozzle to disturb the molding. When ηr is higher than 3.5, the melt viscosity of the resin becomes excessively high, and as a result an inorganic filler may partially come to the surface, depending on the design of a mold, during molding to decrease the gloss of the surface.

The amount of the terminal group of the polyamide resin used in the invention is preferably 10 to 80 milli-equivalent, more preferably 20 to 60 milli-equivalent, as the amino group per 1 kg of polyamide and 60 to 150 milli-equivalent, more preferably 70 to 120 milli-equivalent, as the carboxyl group per 1 kg of polyamide.

The polyamide of the invention can be produced according to a known method of polymerization for polyamide resin. For example, polycondensation may be carried out according to a method of melt polymerization, solid-state polymerization, bulk polymerization, or solution polymerization, or a combination of these methods. Alternatively, solution polymerization or interfacial polymerization may be utilized. Among these methods, melt polymerization or a combination of melt polymerization and solid-state polymerization may preferably be used in view of economical aspect.

(B) Inorganic Fillers

The inorganic filler comprises (b1) glass fiber and (b2) at least one species selected from the group consisting of wollastonite, talc, kaolin and mica.

As the glass fiber, those which have usually been used in thermally plastic resin can be used; there is no limitation on the thickness (diameter) or length of fiber, for example, those of 5 to 30 μm in average thickness including chopped strand, lobing, or milled fiber may be used. When chopped strand is used, its length may be selected in the range of 0.1 to 6 mm.

As for the glass fiber used in the invention, those of 6 to 15μm in average thickness are particularly preferred. The composition in which the glass fiber has this average thickness is preferably used since it has a good mechanical characteristic and is effective in reducing abrasion of a processing apparatus.

In this connection, the ratio (L/D) of length to diameter of the fiber is preferably in the range of from 100 to 300. In this range, it becomes possible to prepare a composition having an excellent balance between processability and mechanical characteristics.

Wollastonite (chemical name: calcium metasilicate) is a mineral in white needle crystal form. In general, it contains 40 to 60% by weight of SiO₂, 40 to 55% by weight of CaO, and other components such as Fe₂O₃, A1₂O₃, MgO, Na₂O, K₂O, etc.

Wollastonite which can be used herein has an oil absorbing capacity of 20 to 50 cc/100 g, a bulk specific gravity of 0.1 to 1.0, a fiber length of 0.1 to 1000 μm, and a thickness of 0.1 to 50 μm.

The average particle size of wollastonite is preferably 50 μm or less, more preferably from 5 to 30 μm. The average particle size is preferably 50 μm or less so as to avoid the possibility that the particles buried on the surface or in the vicinity thereof can be confirmed visually when made into a molded article.

The average particle size means the particle size corresponds to 50% of cumulative particle size distribution obtained by dispersing wollastonite into pure water with stirring, if required under irradiation of ultrasonic wave, so as to have 85% transmittance, and measuring in a method using an apparatus for laser diffraction/scattering particle size distribution. Considering the possibility it can be confirmed visually, it is preferred that the maximum particle size is 100 μm or less.

The wollastonite may be those prepared by pulverizing or if required by classifying naturally existing one or those obtained by synthesis. In addition, it is preferable to use those having a Hunter whiteness of 60 or more and having a pH of 6 to 8 when it is made into a 10% slurry in highly pure water in order to prevent the weather resistance of polyamide from being impaired.

Talc is represented by the chemical formula 4SiO₂.3MgO.H₂O, which is designated as magnesium silicate hydrate. In general, talc ore is pulverized in various ways to particles of 0.1 to 20 μm in size, which are used as fillers for use in plastics. The particle size of talc is preferably 0.5 to 5 μm.

Kaolin, which has the chemical composition Al₂Si₂O₅(OH)₄, can be classified into kaolinite, dickite, nacrite and halloysite depending on the difference of the 1:1 lamination system of two octahedral forms, any of which may be used. In general, kaolin for being blended into polyamide is preferably calcined kaolin having dehydrated structure because it reduces the volatile component in the molded article and improves its stability during molding. The preferred particle size is usually about 0.1 to 3 μm. Highly white kaolin is preferred because of lesser influence on the color tone of the molded article.

Mica has a different crystal structure or chemical composition depending on the producing regions or a method of synthesis, but there is no limitation imposed thereon. The major component of mica used in the invention is SiO₂ and its structure is formed by a set of two plates each of which is constituted by tetrahedron of SiO₄ lying in a hexagonal network plate shape. Between the two plates, there is formed an ionic bond forming an octahedral structure (e.g., Al³⁺, Mg²⁺). This is called a tablet, which is layered to form a laminate, and an alkali metal or alkaline earth metal ion (e.g., K⁺, Li⁺, Na⁺) is placed between the tablets to form an ionic bond. Mica includes white mica, golden mica, black mica and artificial mica, all of which may be used, and it is preferable to use white mica or artificial mica much closer to white. Since the ionic bond between the tablets is weak in mica, mica can be pulverized to flaky particles utilizing this weakness. The higher ratio of the thickness to the width is more effective in improvement of the rigidity in the molded article, and hence such a substance can be used preferably. It is preferred to use mica of about 1 to 30 μm in particle size since it is better in the balance between appearance and rigidity.

These inorganic fillers in using may preferably be treated with a conventional convergent agent or surface treating agent to adhere on the surface. The surface treating agent includes silane-based coupling agents or titanate-based coupling agents, containing an amino or epoxy group. The silane-based coupling agent which can be used includes γ-aminopropyltrimethoxysilane, γ-aminopropyltriethoxysilane, N-β-(aminoethyl)-γ-aminopropyltrimethoxysilane, vinyltriethoxysilane, γ-glycidoxypropyltrimethyoxysilane, and the like. Such a surface treating agent may be applied on the surface of wollastonite in advance or may be added during mixing the polyamide with an inorganic filler.

(C) Carbon black

The carbon black for use in the invention preferably has an average primary particle size of 20 nm or less and an average aggregate size of 50 to 120 nm.

The average primary particle size is 20 nm or less, preferably 10 to 20 nm. The average primary particle size over 20 nm unfavorably makes the jet-black chromaticity decrease. The average primary particle size of carbon black can be determined by observing the primary particles under a transmission or scanning electron microscope to measure more than 400 particles observed in a visual field and calculating the average value.

The average aggregate size is from 50 to 120 nm, preferably 60 to 80 nm. The average aggregate size less than 50 nm tends to make the jet-black chromaticity on an embossed plate markedly fade, and likewise the size over 120 nm makes it markedly fade. Though the reason has not yet been elucidated, it is presumed that the peak of the absorbance of carbon black with respect to the aggregate size thereof might be in this range.

Herein, the average aggregate size is determined by observing the major axis length and minor axis length of carbon black aggregate under an electron microscope for more than 400 aggregates, converting them into the diameter of the corresponding circle, and taking the average thereof.

As the carbon black, preferably used are those meeting with the Japanese Industrial Standards K6221, that is, those having a loss (volatile component) under heating at 950° C. for 7 minutes in the range of 0.5 to 5%, an oil absorption capacity (as measured using dibutyl phthalate) of 50 to 150 cc/100 g, and a specific surface area measured by nitrogen adsorption method of 120 to 150 m²/g.

Carbon black may be prepared by an oil furnace method, a gas furnace method, a channel method or thermal method, but there is no limitation imposed thereon.

In the invention, each component may be blended as follows: (A) 30 to 70 parts by weight of polyamide resin, (B) 70 to 30 parts by weight of inorganic filler, and (C) carbon black in an amount of 0.05 to 10 parts by weight per 100 parts by weight of the sum of components (A) and (B).

The amount of the inorganic filler to be blended is 30 parts by weight or more, preferably 40 parts by weight or more, in view of the strength and rigidity. Moreover, the amount is 70 parts by weight or less, preferably 60 parts by weight or less, from the aspect of the appearance and fluidity of the molded article.

In addition, the weight ratio of wollastonite (b2) to glass fiber (b1) is preferably from 0.2 to 3. The ratio is preferably 0.2 or more from the aspect of weather resistance, particularly the suppression of standing-out of glass fiber, while it is preferably 3 or less from the aspect of the strength and rigidity.

The amount of carbon black to be blended is 0.05 part by weight or more, preferably 0.1 part by weight or more, from the aspect of the suppression of standing-out of glass fiber. The amount is 10 parts by weight or less, preferably 7 parts by weight or less, from the aspect of the strength and rigidity.

(D) Copper Compounds

The copper compound (D) of the invention includes, for example, copper chloride, copper bromide, copper fluoride, copper iodide, copper thiocyanate, copper nitrate, copper acetate, naphthene copper, copper caprylate, copper laurate, copper stearate, acetylacetone copper, cuprous oxide, cupric oxide, and the like, with copper halides such as copper iodide being particularly preferred.

The amount of the copper compound to be added is 5,000 ppm or less, particularly preferably 50 to 2,000 ppm, in terms of copper contained therein based on the weight of polyamide resin (A). Considering corrosion to the metal in a polymerization reactor, extruder, molding machine, and the like or corrosion to the metal inserted into the molded article, the copper compound may preferably be added in an amount of 5,000 ppm or less.

The copper compound is more preferably used in combination with an iodide compound. The iodide compound includes, for example, potassium iodide, magnesium iodide, ammonium iodide, and the like, and it may be used as iodine per se. More preferably, potassium iodide is used. The iodide compound may preferably be added so that the gram atom ratio of iodine element to copper element ([iodine]/[copper]) is in the range of 5 to 30, more preferably 10 to 25. When the ratio is smaller than 5, the weather resistance is not improved sufficiently, and the ratio larger than 30 often leads to corrosion to the metal in a polymerization reactor, extruder, molding machine, and the like or corrosion to the metal inserted into the molded article.

(E) Azine Dyes

In the invention, a combination of an azine dye (E) with carbon black is effective in improving gloss of the molded article.

Azine dye is a mixture of azine compounds such as triphenazine oxazine or phenazine azine which are prepared, for example, from aniline, nitrobenzene and hydrochloric acid as major starting compounds in the presence of ferric oxide as a catalyst, and it is well known as black-coloring agent for plastics, leather, etc. As such an azine dye, there can be used those commercially available in the name of Nigrosine Base EXBP, Nubian Complex Black G-02, Nubian Black PA-0800, Nubian Black PA-0801, Nubian Black PA-0850, Nubian Black PA-2800, Nubian Black PA-2801, Nubian Black PA-9800, Nubian Black PA-9801, Nubian Black PA-9811, Nubian Black PA-9802, Nubian Black PA-9803, Nubian Black EP-3, Nigrosine Base EE, Nigrosine Base EX, Special Black EB, Nigrosine Base SA, Nigrosine Base SAP, and Nigrosine Base NB, Orient Spirit Black SB (all available from Orient Chemical Ind.), Spirit Black No.850 (Sumitomo Chem. Co.), Nigrosine Base LK (BASF), NYB27620B (Sanyo Kako KK), and the like.

The amount of the azine dye to be blended is 0.01 to 2 parts by weight, preferably 0.05 to 1.5 parts by weight, and more preferably 0.1 to 1.0 part by weight, per 100 parts by weight of polyamide (A). The amount of the azine dye over 10 parts by weight decreases gloss and jet-black chromaticity of the molded article and increases discoloration of black after a weather resistance test. In general, this type of azine dyes often exhibits acidity, and in this invention, the azine dyes exhibiting pH 5 or higher are preferably used since they do not accelerate decomposition of polymer.

As far as the purpose of the invention is not impaired, it is possible to add an additive or additives usually used in polyamide resin as needed to the polyamide resin composition of the invention. Examples of the additive include anti-oxidant, ultraviolet ray absorbing agent, thermal stabilizer, photo-deterioration inhibitor, plasticizer, lubricant, mold-releasing agent, nuclear agent, flame retardant, coloring dye such as copper phthalocyanine, and the like. Alternatively, the polyamide resin of the invetion may be blended with other type of thermal plastic resin.

The composition of highly weather resistant polyamide and the molded article of the invention may be prepared by blending the aforementioned components and if required a variety of additives.

In carrying out blending, mixing and kneading, there is no limitation as to their method or order. The mixing may be achieved with a conventional mixer, for example, Henshel-type mixer, tumbler, ribbon blender, and so on. As for the kneader, a conventional uniaxial or twin-screw extruder may be used. In producing the molded article, first the resin composition of the invention is converted into pellets, which are then formed into an optional shape by means of compressive forming, injection molding or extrusion to obtain a desired resin product.

In the invention, there is no particular limitation imposed on the condition of injection molding, though it is usually carried out at a molding temperature of 250 to 310° C. and at a mold temperature of 40 to 120° C.

In preparing the resin composition of the invention, there is no particular limitation imposed on the order of mixing. In carrying out melt-kneading, all of the components are kneaded together or alternatively a part of the components is melt-kneaded and the remaining part is added thereto and further melt-kneaded. Alternatively, a part of the components is melt-kneaded to prepare pellets, to which is added the remaining part to prepare blended pellets. Moreover, carbon black (C) is added to a polyamide (A) to prepare master pellets containing carbon black at a high concentration, which are admixed with other components and melt-kneaded or subjected to pellets-blending.

The polyamide resin composition of the invention can be used in a field in which strength/rigidity and weather resistance are required. In particular, they can be applied to the utility in parts used outdoors such as exterior parts of automobiles or to the utility in a bath room in which use of water is expected.

For example, the automobile parts include outer door handle, hubcap, roof rail, side mirror base, inside rear-view mirror arm, sunroof deflector, radiator fun, radiator grill, bearing retainer, console box, sun visor arm, spoiler, slide door rail cover, and the like. The water-related application includes, for example, a grip bar in a bath room.

Additionally, the compositions may be applied to the utility in which a good appearance of the molded article is required, for example, various office equipments such as legs of desk and chair, seat support or armrest, as well as parts of wheelchair, door knob, handrail, grip bar, window knob, window lock, industrial molded articles such as grating materials, and molded articles for miscellaneous goods.

### EXAMPLES

The present invention will be illustrated in greater detail with reference to the following Examples and Comparative Examples, but the invention should not be construed as being limited thereto. The evaluations were made in the following manner.

(1) Determination of the Concentration of an Aromatic Ring-Containing Polymer Unit in the Polyamide

The concentration of an aromatic ring-containing polymer unit was determined as follows. The polyamide was dissolved in deuterated trifluoroacetic acid so that the concentration of the polyamide resin composition was in 2% by weight, for which ¹H-NMR was measured using a Brucker's AC-300P. Thus, the concentration of the polymer unit containing an aromatic ring was calculated from the integral value of proton peaks. The condition for determination was as follows.

Temperature of measurement: 30° C. Width of pulse: 4.4 μsec Repetition time of pulse: 3.0 sec Frequency of integration: 128 runs

For determination of the chemical shift, tetramethylsilane was used as a standard.

(2) Gloss of the Surface

Using an injection-molding machine IS150 (Toshiba Machine Co.), a plate molded by extrusion (100×90×3 mm) was obtained at a cylinder temperature of 290° C. and a mold temperature of 120° C. while the injection pressure and velocity were adjusted so that the filling time became about 1.5 seconds. Using this plate, the gloss at 60° was measured on a gloss meter (HORIBA IG320) according to the JIS-K7150.

(3) Jet-Black Chromaticity

For the above-described extruded plate, jet-black chromaticity (L value) was measured by means of a calorimeter ND-300A (Nippon Densyoku).

(4) Color Difference (BE)

Before and after the weather resistance test as mentioned below, the values L, a and b in a center portion of an embossed plate were measured with a calorimeter ND-300A (Nippon Densyoku), and the color difference (AE) was calculated.

(5) Mechanical Characteristics

Using an injection-molding machine IS-50EP (Toshiba Machine Co.), an ASTM type 1 of 3 mm in thickness was molded in a molding condition of 200 rpm in rotational frequency and a resin temperature of 290° C. This molded piece was used as a specimen for measuring tensile strength at break and flexural modulus according to ASTM D638 and D790, respectively.

(6) Weather Resistance (ΔE, Rate-of-Change in Gloss, and Standing-Out of Glass Fiber)

Using an injection molding machine FN3000 (Nissei Plastic Ind.), injection molded plates were prepared with molds for embossed plate (60 mm×90 mm×3 mm) and for glossy plate (60 mm×90 mm×3 mm).

The resulting injection molded plates were subjected to exposure to light with a cycle condition of a black panel temperature of 83° C. and atomization of water for 12 minutes per 60 minute irradiation for the total period of 500 hours using a WEL-SUN-DCH type weather resistance test machine equipped with a sunshine carbon arc lamp (Suga Shikennki KK).

The evaluation after the weather resistance test was made by measuring color tone of the molded plate before and after the exposure and then determining the color difference with a calorimeter ND-300A (Nippon Densyoku). Smaller difference of color (ΔE) indicates better weather resistance.

The rate-of-change in gloss on an embossed plate is determined by measuring the gloss at 60° on the molded glossy plate using a gloss meter (HORIBA IG320) according to the JIS-K7150 before and after exposure, wherein the gloss value after exposure is shown based on the value before exposure which is regarded as 100%.

Concerning the standing-out of glass fiber on an embossed plate, the embossed plate after exposure was observed with a loupe of 50 magnifications for evaluation. The symbol “A” indicates no glass fiber observed; “B” indicates that glass fiber observed in a less than 20% field of vision; and “C” indicates that glass fiber observed in a 20% or more field of vision.

The followings indicate the starting materials used in Examples of the invention.

(A) Polyamide

A1: Polyamide 66/6I copolymer obtained in Polymerization Example 1 mentioned below;

A2: Polyamide 66/6I/6 copolymer obtained in Polymerization Example 2 mentioned below;

A3: Polyamide 66/6I copolymer obtained in Polymerization Example 3 mentioned below;

A4: Polyamide 66/6I copolymer obtained in Polymerization Example 4 mentioned below;

A5: Polyamide MXD6, made by Mitsubishi Engineering Resin Co.; trade name Reny 6002;

(B) Inorganic fillers

B1: Glass fiber; made by Nippon Electric Glass Co.; trade name CS03T275H; average thickness 10 μm;

B2: Wollastonite; made by Nyco Co.; trade name Nyglos 8; average particle size=8 μm;

B3: Talc; made by Tatsumori Co.; trade name CRS6002; surface treated with aminosilane; average particle size=5.1 μm;

B4: Burned kaolin; made by Engelhard Corp.; trade name TRANSLINK 445; average particle size=1.4 μm;

B5: Mica; made by Yamaguchi Unmo; trade name A-21; average particle size=22.5 μm; whiteness=85

(C) Carbon Black

C1: Carbon black; made by Cabbott Co.; trade name 9A32; average aggregate size 70 nm; average primary particle size 19 nm;

C2: Carbon black; made by Mitsubishi Chem. Ind.; trade name #980b; average aggregate size 45 nm; average primary particle size 16 nm;

C3: Carbon black; made by Mitsubishi Chem. Ind.; trade name #44; average aggregate size 70 nm; average primary particle size 24 nm

(E) Azine Dye

E1: Nigrosine: made by Orient Chemical Ind.; trade name Nubian black PA9801

### Polymerization Example 1

In a 5L autoclave were placed 2.00 kg of the equimolar salt of adipic acid and hexamethylenediamine, 0.50 kg of equimolar salt of isophthalic acid and hexamethylenediamine, 0.10 kg of adipic acid, 29 g of copper iodide, 480 g of potassium iodide and 2.5 kg of pure water, and the mixture was stirred well. After sufficient replacement with nitrogen, the temperature was raised from room temperature to 220° C. with stirring over about 1 hour. During this operation, the internal pressure in the autoclave reached 18 kg/cm²-G due to spontaneous pressure of water vapor, while water was removed outside the reaction system under heating so that the pressure did not exceed 18 kg/cm²-G. After the lapse of 2 hours, the inside temperature reached 260° C. At this point, the heating was stopped, and the outlet valve of the autoclave closed, and the temperature allowed to fall to room temperature over about 8 hours. After cooling, the autoclave was opened, from which about 2 kg of polymer was taken out and pulverized. The pulverized polymer was placed in a 10 L evaporator and heated at 200° C. under nitrogen stream for 10 hours for solid-state polymerization.

The polyamide obtained by solid-state polymerization contained 18.8 mole % of hexamethylene isophthalamide unit, of which the content of the terminal carboxyl group was 102.1 milli equivalents per 1 kg of polymer and the content of the terminal amino group was 44.1 milli equivalents per 1 kg of polymer. This polyamide contained 96 ppm of copper element, and the molar ratio of the copper-containing component to the iodine-containing component was 19.

### Polymerization Example 2

In a 5L autoclave were placed 1.90 kg of the equimolar salt of adipic acid and hexamethylenediamine, 0.40 kg of equimolar salt of isophthalic acid and hexamethylenediamine, 0.2 kg of e-caprolactam, 0.10 kg of adipic acid, 29 g of copper iodide, 480 g of potassium iodide and 2.5 kg of pure water, and the mixture was stirred well. After sufficient replacement with nitrogen, the temperature was raised from room temperature to 220° C. with stirring over about 1 hour. During this operation, the internal pressure in the autoclave reached 18 kg/cm²-G due to spontaneous pressure of water vapor, while water was removed outside the reaction system under heating so that the pressure did not exceed 18 kg/cm²-G. After the lapse of 2 hours, the inside temperature reached 260° C. At this point, the heating was stopped, and the outlet valve of the autoclave closed, and the temperature allowed to fall to room temperature over about 8 hours. After cooling, the autoclave was opened, from which about 2 kg of polymer was taken out and pulverized. The pulverized polymer was placed in a 10 L evaporator and heated at 200° C. under nitrogen stream for 10 hours for solid-state polymerization.

The polyamide obtained by solid-state polymerization contained 14.0 mole % of hexamethylene isophthalamide unit. This polyamide contained 96 ppm of copper element, and the molar ratio of the copper-containing component to the iodine-containing component was 19.

### Polymerization Example 3

In a 5L autoclave were placed 1.75 kg of the equimolar salt of adipic acid and hexamethylenediamine, 0.75 kg of equimolar salt of isophthalic acid and hexamethylenediamine, 0.10 kg of adipic acid and 2.5 kg of pure water, and the mixture was stirred well. After sufficient replacement with nitrogen, the temperature was raised from room temperature to 220° C. with stirring over about 1 hour. During this operation, the internal pressure in the autoclave reached 18 kg/cm²-G due to spontaneous pressure of water vapor, while water was removed outside the reaction system under heating so that the pressure did not exceed 18 kg/cm²-G. After the lapse of 2 hours, the inside temperature reached 260° C. At this point, the heating was stopped, and the outlet valve of the autoclave closed, and the temperature allowed to fall to room temperature over about 8 hours. After cooling, the autoclave was opened, from which about 2 kg of polymer was taken out and pulverized. The pulverized polymer was placed in a 10 L evaporator and heated at 200° C under nitrogen stream for 10 hours for solid-state polymerization.

The polyamide obtained by solid-state polymerization contained 27.3 mole % of hexamethylene isophthalamide unit, of which the content of the terminal carboxyl group was 102.6 milli equivalents per 1 kg of polymer and the content of the terminal amino group was 44.3 milli equivalents per 1 kg of polymer.

### Polymerization Example 4

In a 5L autoclave were placed 2.00 kg of the equimolar salt of adipic acid and hexamethylenediamine, 0.50 kg of equimolar salt of isophthalic acid and hexamethylenediamine, 0.10 kg of adipic acid and 2.5 kg of pure water, and the mixture was stirred well. After sufficient replacement with nitrogen, the temperature was raised from room temperature to 220° C. with stirring over about 1 hour. During this operation, the internal pressure in the autoclave reached 18 kg/cm²-G due to spontaneous pressure of water vapor, while water was removed outside the reaction system under heating so that the pressure did not exceed 18 kg/cm²-G. After the lapse of 2 hours, the inside temperature reached 260° C. At this point, the heating was stopped, and the outlet valve of the autoclave closed, and the temperature allowed to fall to room temperature over about 8 hours. After cooling, the autoclave was opened, from which about 2 kg of polymer was taken out and pulverized. The pulverized polymer was placed in a 10 L evaporator and heated at 200° C. under nitrogen stream for 10 hours for solid-state polymerization.

The polyamide obtained by solid-state polymerization contained 18.8 mole % of hexamethylene isophthalamide unit, of which the content of the terminal carboxyl group was 102.1 milli equivalents per 1 kg of polymer and the content of the terminal amino group was 44.1 milli equivalents per 1 kg of polymer.

### Example 1

Using a twin-screw extruder TEM35( (Toshiba Machine Co.)(set temperature 290° C., screw rotation frequency 300 rpm), 40 parts by weight of polyamide A1 and 1.5 parts by weight of carbon black Cl were supplied therein through a top feed-opening, while 25 parts by weight of the inorganic filler B2 was supplied through an upstream side feed-opening and 35 parts by weight of the glass fiber B1 through a downstream side feed-opening. The melt-kneaded product extruded from the mold head was cooled in a strand state and pelletized to obtain a polyamide resin composition. The resulting composition was evaluated as mentioned above. Table 1 shows the constitution and the evaluation results.

The molded article after a weather resistance test had a very small change in color difference in black, and no standing-out of glass fiber was observed.

### Example 2

In the same manner as in Example 1, a polyamide resin composition was prepared, except that the polyamide was replaced with A2. Table 1 shows the constitution and the evaluation results.

### Examples 3 to 5

In the same manner as in Example 1, polyamide resin compositions were prepared, except that the inorganic filler was replaced with those as shown in Table 1. Table 1 shows the constitution and the evaluation results.

### Example 6

Using a twin-screw extruder TEM35φ (Toshiba Machine Co.)(set temperature 290° C., screw rotation frequency 300 rpm), 50 parts by weight of polyamide A5, 1.0 part by weight of carbon black C1, 150 ppm of copper iodide (calculated as the copper content for the total polyamide) and potassium iodide (in an amount so that the molar ratio of the copper atom to the total iodine was 20) were supplied therein through a top feed-opening, while 25 parts by weight of the inorganic filler B2 was supplied through an upstream side feed-opening and 25 parts by weight of the glass fiber B1 through a downstream side feed-opening. The melt-kneaded product extruded from the spinning opening was cooled in a strand state and pelletized to obtain a polyamide resin composition. The resulting composition was evaluated as mentioned above. Table 1 shows the constitution and the evaluation results.

### Example 7

In the same manner as in Example 1, a polyamide resin composition was prepared, except that the blending amounts were altered to 65 parts by weight of polyamide A1, 10 parts by weight of glass fiber B1 and 25 parts by weight of inorganic filler B2. Table 1 shows the constitution and the evaluation results.

### Example 8

In the same manner as in Example 1, a polyamide resin composition was prepared, except that the blending amounts were altered to 45 parts by weight of glass fiber B1 and 15 parts by weight of inorganic filler B2. Table 1 shows the constitution and the evaluation results.

### Comparative Example 1

In the same manner as in Example 1, a polyamide resin composition was prepared, except that no inorganic filler B2 was added and the blending amount of the glass fiber B1 was altered to 60 parts by weight. Table 1 shows the constitution and the evaluation results.

### Comparative Example 2

In the same manner as in Example 1, a polyamide resin composition was prepared, except that no glass fiber B1was added and the blending amount of the inorganic filler B2 was altered to 40 parts by weight. Table 1 shows the constitution and the evaluation results.

### Example 9

In the same manner as in Example 1, a polyamide resin composition was prepared, except that 0.3 part by weight of azine dye E1 was further blended. Table 2 shows the constitution and the evaluation results.

### Examples 10 and 11

In the same manner as in Example 1, polyamide resin compositions were prepared, except that the amounts of carbon black to be blended were altered as shown in Table 2. Table 2 shows the constitution and the results of evaluation.

### Comparative Examples 3 and 4

In the same manner as in Example 1, polyamide resin compositions were prepared, except that the type of carbon black was varied as shown in Table 2. Table 2 shows the constitution and the results of evaluation.

### Comparative Example 5

In the same manner as in Example 1, a polyamide resin composition was prepared, except that the amounts of carbon black to be blended was altered to 15 parts by weight. Table 2 shows the constitution and the evaluation results.

### Example 12

In the same manner as in Example 1, a polyamide resin composition was prepared, except that the type of polyamide was altered to A3. Table 2 shows the constitution and the evaluation results.

### Example 13

Using a twin-screw extruder TEM35((Toshiba Machine Co.)(set temperature 290° C., screw rotation frequency 300 rpm), 40 parts by weight of polyamide A4, 1.5 part by weight of carbon black C1, 5 ppm of copper iodide (calculated as the copper content for the total polyamide) and potassium iodide (in an amount so that the molar ratio of the copper atom to the total iodine was 20) were supplied therein through a top feed-opening, while 25 parts by weight of the inorganic filler B2 was supplied through an upstream side feed-opening and 35 parts by weight of the glass fiber B1 through a downstream side feed-opening. The melt-kneaded product extruded from the mold head was cooled in a strand state and pelletized to obtain a polyamide resin composition. The resulting composition was evaluated as mentioned above. Table 2 shows the constitution and the evaluation results.

### Example 14

In the same manner as in Example 13, a polyamide resin composition was prepared, except that no copper iodide and potassium iodide were blended. Table 2 shows the constitution and the evaluation results.

TABLE 1

| | Ex 1 | Ex 2 | Ex 3 | Ex 4 | Ex 5 | Ex 6 | Ex 7 | Ex 8 | C.Ex 1 | C.Ex 2 |
|---|---|---|---|---|---|---|---|---|---|---|
| (A) Polyamide resin | | | | | | | | | | |
| Type | A1 | A2 | A1 | A1 | A1 | A5 | A1 | A1 | A1 | A1 |
| Blended amount (parts by weight) | 40 | 40 | 40 | 40 | 40 | 50 | 65 | 40 | 40 | 60 |
| Aromatic ring-containing polymer unit | 18.8 | 14.0 | 18.8 | 18.8 | 18.8 | 88.2 | 18.8 | 18.8 | 18.8 | 18.8 |
| concentration in entire resin | | | | | | | | | | |
| (B) Inorganic filler | | | | | | | | | | |
| Type | B1 | B1 | B1 | B1 | B1 | B1 | B1 | B1 | B1 | — |
| Blended amount (parts by weight) | 35 | 35 | 35 | 35 | 35 | 25 | 10 | 45 | 60 | — |
| Type | B2 | B2 | B3 | B4 | B5 | B2 | B2 | B2 | — | B2 |
| Blended amount (parts by weight) | 25 | 25 | 25 | 25 | 25 | 25 | 25 | 15 | — | 40 |
| Wt ratio of filler (B2-B5) to glass fiber (B1) | 0.7 | 0.7 | 0.7 | 0.7 | 0.7 | 1.0 | 2.5 | 0.3 | — | — |
| (C) Carbon black | | | | | | | | | | |
| Type | C1 | C1 | C1 | C1 | C1 | C1 | C1 | C1 | C1 | C1 |
| Aggregate size (nm) | 70 | 70 | 70 | 70 | 70 | 70 | 70 | 70 | 70 | 70 |
| Primary Particle size (nm) | 19 | 19 | 19 | 19 | 19 | 19 | 19 | 19 | 19 | 19 |
| Blended amount (parts by weight) | 1.5 | 1.5 | 1.5 | 1.5 | 1.5 | 2.5 | 1.5 | 1.5 | 1.5 | 1.5 |
| (E) Copper compound | 96 | 96 | 96 | 96 | 96 | 150 | 96 | 96 | 96 | 96 |
| Cu concentration (ppm to (A)) | | | | | | | | | | |
| (F) Azine dye | 0 | 0 | 0 | 0 | 0 | 0 | 0 | 0 | 0 | 0 |
| Blended amount (parts by weight to (A)) | | | | | | | | | | |
| Mechanical character | | | | | | | | | | |
| Tensile strength at break (MPa) | 180 | 175 | 173 | 170 | 185 | 220 | 162 | 185 | 219 | 125 |
| Flexural modulus (GPa) | 17 | 17 | 16 | 16 | 18 | 18 | 15 | 17 | 17 | 14 |
| Appearance of product | | | | | | | | | | |
| Gloss value | 76 | 87 | 80 | 84 | 82 | 85 | 90 | 80 | 76 | 81 |
| L value (jet-black chromaticity)*1 | 4 | 4 | 4 | 4 | 4 | 4 | 4 | 4 | 3 | 4 |
| Weather resistance (embossed plate) | | | | | | | | | | |
| ΔE | 2 | 2 | 2 | 2 | 2 | 2 | 2 | 2 | 5 | 13 |
| Gloss change (%) | 80 | 80 | 82 | 80 | 86 | 83 | 81 | 82 | 60 | 79 |
| Standing out glass fiber | A | A | A | A | A | B | A | A | C | A |
| Weather resistance (glossy plate) | 21 | 20 | 20 | 21 | 18 | 20 | 21 | 21 | 32 | 40 |
| ΔE | | | | | | | | | | |

*1Smaller L value gives better jet-black chromaticity.

TABLE 2

| | Ex 9 | Ex 10 | Ex 11 | C.Ex 3 | C.Ex 4 | C.Ex 5 | C.Ex 12 | C.Ex 13 | C.Ex 14 |
|---|---|---|---|---|---|---|---|---|---|
| (A) Polyamide resin | | | | | | | | | |
| Type | A1 | A2 | A1 | A1 | A1 | A1 | A3 | A4 | A4 |
| Blended amount (parts by weight) | 40 | 40 | 40 | 40 | 40 | 40 | 40 | 40 | 40 |
| Aromatic ring-containing polymer unit | 18.8 | 18.8 | 18.8 | 18.8 | 18.8 | 18.8 | 27.3 | 18.8 | 18.8 |
| concentration in entire resin | | | | | | | | | |
| (B) Inorganic filler | | | | | | | | | |
| Type | B1 | B1 | B1 | B1 | B1 | B1 | B1 | B1 | B1 |
| Blended amount (parts by weight) | 35 | 35 | 35 | 35 | 35 | 35 | 35 | 35 | 35 |
| Type | B2 | B2 | B2 | B2 | B2 | B2 | B2 | B2 | B2 |
| Blended amount (parts by weight) | 25 | 25 | 25 | 25 | 25 | 25 | 25 | 25 | 25 |
| Wt ratio of filler (B2-B5) to glass fiber (B1) | 0.7 | 0.7 | 0.7 | 0.7 | 0.7 | 0.7 | 0.7 | 0.7 | 0.7 |
| (C) Carbon black | | | | | | | | | |
| Type | C1 | C1 | C1 | C2 | C3 | C1 | C1 | C1 | C1 |
| Aggregate size (nm) | 70 | 70 | 70 | 45 | 70 | 70 | 70 | 70 | 70 |
| Primary Particle size (nm) | 19 | 19 | 19 | 16 | 24 | 19 | 19 | 19 | 19 |
| Blended amount (parts by weight) | 1.5 | 0.5 | 7.5 | 1.5 | 1.5 | 15 | 1.5 | 1.5 | ⅕ |
| (E) Copper compound | 96 | 96 | 96 | 96 | 96 | 96 | 96 | 5 | — |
| Cu concentration (ppm to (A)) | | | | | | | | | |
| (F) Azine dye | 0.3 | 0 | 0 | 0 | 0 | 0 | 0 | 0 | 0 |
| Blended amount (parts by weight to (A)) | | | | | | | | | |
| Mechanical character | | | | | | | | | |
| Tensile strength at break (MPa) | 180 | 180 | 180 | 180 | 180 | 80 | 180 | 180 | 180 |
| Flexural modulus (GPa) | 17 | 16 | 17 | 17 | 17 | 18 | 17 | 17 | 17 |
| Appearance of product | | | | | | | | | |
| Gloss value | 93 | 86 | 85 | 84 | 84 | 66 | 88 | 82 | 82 |
| L value (jet-black chromaticity)*1 | 3 | 5 | 5 | 3 | 8 | 3 | 3 | 3 | 3 |
| Weather resistance (embossed plate) | | | | | | | | | |
| ΔE | 2 | 3 | 2 | 7 | 4 | 10 | 2 | 3 | 4 |
| Gloss change (%) | 72 | 73 | 73 | 73 | 73 | 90 | 82 | 83 | 81 |
| Standing out glass fiber | A | A | A | A | B | A | A | A | A |
| Weather resistance (glossy plate) | 18 | 19 | 18 | 19 | 19 | 23 | 20 | 21 | 21 |
| ΔE | | | | | | | | | |

*1Smaller L value gives better jet-black chromaticity.

The polyamide resin compositions of the invention when made into molded articles have much better mechanical characteristic, appearance and weather resistance than conventional ones, and in particular they exhibit high resistance to discoloration of jet black and change in gloss without causing standing-out of glass fiber even under an outdoor condition, particularly under a condition including a rainfall. Thus, they can be utilized in various areas, particularly including exterior parts of automobiles which have so far been made from a metal, for example, outer door handle, hubcap, roof rail, side mirror base, inside rear-view mirror arm, sunroof deflector, radiator fun, bearing retainer, and the like.

While the present invention has been described in detail and with reference to specific embodiments thereof, it will be apparent to one skilled in the art that various changes and modifications can be made therein without departing from the spirit and scope thereof.

The present application is based on Japanese Patent Applications No. 2002-323607 filed on Nov. 7, 2002 and No. 2003-109241 filed on Apr. 14, 2003, and the entire contents thereof being hereby incorporated by reference.

What is claimed is:

1. A polyamide resin composition which comprises:
(A) 30 to 70 parts by weight of a polyamide resin;
(B) 70 to 30 parts by weight of an inorganic filler; and
(C) carbon black in an amount of 0.05 to 10 parts by weight per 100 parts by weight of the sum of components (A) and (B), wherein
said inorganic filler (B) comprises (b1) glass fiber, and (b2) at least one species selected from the group consisting of wollastonite, talc, kaolin and mica;
said carbon black (C) has an average primary particle size of 20 nm or less and an average aggregate size of 50 to 120 nm.

2. The polyamide resin composition according to claim 1, wherein said polyamide resin comprises a semi-aromatic polyamide and contains an aromatic-containing polymer unit in an amount of 10 to 90 mole %.

3. The polyamide resin composition according to claim 1, wherein said polyamide resin (A) is a semi-aromatic polyamide comprising:
60 to 95% by weight of a hexamethylene adipamide unit;
0 to 10% by weight of a capramideunit; and
5 to 40% by weight of hexamethylene isophthalamide unit.

4. The polyamide resin composition according to claim 1, wherein said inorganic filler (B) comprises glass fiber and wollastonite.

5. The polyamide resin composition according to claim 1, wherein the weight ratio of (b2) to (b1) is from 0.2 to 3.

6. The polyamide resin composition according to claim 1, further comprising (D) a copper compound in an amount of 5,000 ppm or less in terms of copper contained therein based on the weight of component (A).

7. The polyamide resin composition according to claim 1, further comprising (E) an azine dye in an amount of 0.01 to 2 parts by weight per 100 parts by weight of component (A).

8. A molded article obtained by molding a polyamide resin composition according to any of claims 1 to 7.

9. The molded article according to claim 8, which is selected from the group consisting of outer handle, outer door handle, hubcap, roof rail, side mirror base, inside rear-view mirror arm, sunroof deflector, radiator fun, radiator grill, bearing retainer, console box, sun visor arm, spoiler, slide door rail cover, legs of desk and chair, seat support, armrest, parts of wheelchair, door knob, handrail, grip bar, window knob and window lock.
